(19) United States
(12) Patent Application Publication
(10) Pub. No.: US 2019/0345319 A1
(43) Pub. Date: Nov. 14, 2019

(54) COMPOSITE COMPRISING A FLUOROELASTOMER AND A POLYIMIDE, METHOD FOR MAKING THE COMPOSITE AND ARTICLES COMPRISING IT

(71) Applicant: SABIC Global Technologies B.V., Bergen op Zoom (NL)

(72) Inventors: Liang Shen, Shanghai (CN); Huabin Liu, Shanghai (CN); Mian Dai, Shanghai (CN); Wei Shan, Shanghai (CN)

(21) Appl. No.: 16/302,349

(22) PCT Filed: May 19, 2017
(86) PCT No.: PCT/IB2017/052978

§ 371 Date: Nov. 16, 2018

Related U.S. Application Data
(60) Provisional application No. 62/339,394, filed on May 20, 2016.

(51) Int. Cl. C08L 27/20; C08J 3/00

(52) U.S. Cl. CPC C08L 27/20; C08J 2379/08; C08J 2327/20; C08J 3/005

(57) ABSTRACT

A composite includes a fluoroelastomer, 0.1 to 5.0 parts by weight of a vulcanizing agent, based on 100 parts by weight of the fluoroelastomer, 5 to 50 parts by weight of a polyimide, based on 100 parts by weight of the fluoroelastomer, and 0 to 20 parts by weight of an additive composition, based on 100 parts by weight of the fluoroelastomer, wherein the polyimide comprises 5 to 1000 units of the formula:

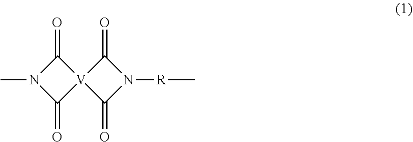

wherein each V is the same or different, and is a substituted or unsubstituted tetravalent C₄₋₄₀ hydrocarbon group, and each R is the same or different, and is a substituted or unsubstituted C₂₋₂₀ divalent organic group. A method of manufacturing the composites and articles are also described.

### BACKGROUND

Fluoroelastomers such as perfluoroelastomers are currently used in a variety of applications in which severe environments are encountered, including high temperatures and aggressive chemicals. For example, fluoroelastomers find use as O-rings, gaskets, pipes, fittings, hoses, stem seals, shaft seals, diaphragms, electric wires, shock-absorbing materials, and the like, which are used under severe environments such as in automotive, aerospace, and oil and gas applications. Fluoropolymers provide excellent mechanical properties as well as resistance to substances such as mineral oils, hydraulic fluids, solvents, and chemical agents of diverse nature over a wide range of working temperatures, from low to high temperatures. One problem with conventional fluoroelastomers, however, is that they can have poor adhesion, particularly to metal surfaces.

Accordingly, there remains a continuing need in the art for improved fluoroelastomer composites, particularly composites with improved adhesion to metal surfaces.

### SUMMARY

A composite comprises

a fluoroelastomer,

0.1 to 5.0 parts by weight of a vulcanizing agent, based on 100 parts by weight of the fluoroelastomer,

5 to 50 parts by weight of a polyimide, based on 100 parts by weight of the fluoroelastomer, and

0 to 20 parts by weight of an additive composition, based on 100 parts by weight of the fluoroelastomer,

wherein the polyimide is a homopolymer or copolymer having 5 to 1000 units of the formula:

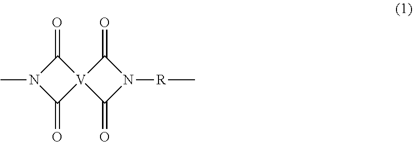

wherein each V is the same or different, and is a substituted or unsubstituted tetravalent C₄₋₄₀ hydrocarbon group, and

each R is the same or different, and is a substituted or unsubstituted C₂₋₂₀ divalent organic group.

A method of making a composite comprises blending a fluoroelastomer, 0.1 to 5.0 parts by weight of a vulcanizing agent per hundred parts of the fluoroelastomer, 5 to 50 parts by weight of a polyimide per hundred parts of the fluoroelastomer, and 0 to 20 parts by weight of an additive composition based per hundred parts by weight of the fluoroelastomer, and curing the blend to provide a composite comprising the polyimide substantially evenly dispersed in the fluoroelastomer.

Also included is a metal substrate comprising the composite and an article comprising the metal substrate.

The above-described and other features are exemplified by the following figures and detailed description.

### BRIEF DESCRIPTION OF THE DRAWINGS

The following figure is an exemplary embodiment.

FIGS. 1A and 1B are SEM images of a neat FKM fluoroelastomer compared to a PEI/FKM composite of the present disclosure.

FIG. 2 shows a seal for automotive transmission gear box bench testing.

FIG. 3 shows SEMs of a fluoroelastomer composition with PEI. FIG. 3A is an SEM of the composition of Example 4 before cure. FIG. 3B is an SEM of the composition of Example 4 after cure.

FIG. 4 shows SEMs of a fluoroelastomer composition with PEI. FIG. 4A is an SEM of the composition of Example 5 before cure. FIG. 4B is an SEM of the composition of Example 5 after cure.

### DETAILED DESCRIPTION

The present inventors have discovered that fluoroelastomers can have poor metal adhesion performance, particularly when used for oil sealing and vibration absorbing applications. The inventors found that a composite of a fluoroelastomer with a polyimide exhibited good miscibility between the fluoroelastomer and the polyimide and that the polyimide was well-dispersed and distributed in the fluoroelastomer matrix. The composites had both superior mechanical properties and metal adhesion performance.

In an embodiment, a composite comprises a fluoroelastomer, a vulcanizing agent, a polyimide, and an additive composition. The composite can comprise a fluoroelastomer, 0.1 to 5.0 parts by weight of a vulcanizing agent, based on 100 parts by weight of the fluoroelastomer, 5 to 50 parts by weight of the polyimide based on 100 parts by weight of the fluoroelastomer, and 0 to 20 parts by weight of the additive composition based on 100 parts by weight of the fluoroelastomer. Exemplary composites are polyimide-filled fluoroelastomers in which the polyimide is substantially fully dispersed in the fluoroelastomer. Substantial dispersion of the polyimide in the fluoroelastomer can be observed using SEM imaging, wherein substantially no aggregation or phase separation of the polyimide are observed. In an embodiment, the composite is a cured composite.

In an embodiment, the composite or cured composite has a tensile strength that is at least 25% greater than that of the neat fluoroelastomer measured according to ASTM D 412.

In an embodiment, the composite or cured composite has superior metal adhesion compared to the same composition without the polyimide. Adhesion can be measured using the cross cut tap test according to ASTM D3359, the peeling testing according to ASTM D1876, or a combination thereof. Improved adhesion comprises a 10% or greater improvement in adhesion based upon one or both of the foregoing tests.

The fluoroelastomer may be categorized under ASTM D1418 and the ISO 1629 designation of FKM, for example. The fluoroelastomer can include a copolymer of hexafluoropropylene (HFP) and vinylidene fluoride (VDF or VF2), terpolymers of tetrafluoroethylene (TFE), vinylidene fluoride, and hexafluoropropylene, perfluoromethylvinylether (PMVE), copolymers of TFE and propylene, and copolymers of TFE, PMVE. A combination comprising at least one of the foregoing fluoroelastomers can be used. The fluorine content typically varies, for example 66 to 70 wt %, based on the total weight of the fluoroelastomer. FKM is a fluoro-rubber of the polymethylene type having substituent fluoro and perfluoroalkyl or perfluoroalkoxy groups on the polymer chain.

Polyimides comprise more than 1, for example 3 to 1000, or 5 to 500, or 10 to 100, structural units of formula (1)

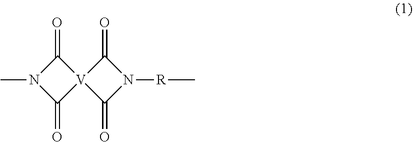

wherein each V is the same or different, and is a substituted or unsubstituted tetravalent C₄₋₄₀ hydrocarbon group, for example a substituted or unsubstituted C₆₋₂₀ aromatic hydrocarbon group, a substituted or unsubstituted, straight or branched chain, saturated or unsaturated C₂₋₂₀ aliphatic group, or a substituted or unsubstituted C₄₋₈ cycloalkylene group or a halogenated derivative thereof, in particular a substituted or unsubstituted C₆₋₂₀ aromatic hydrocarbon group. Exemplary aromatic hydrocarbon groups include any of those of the formulas

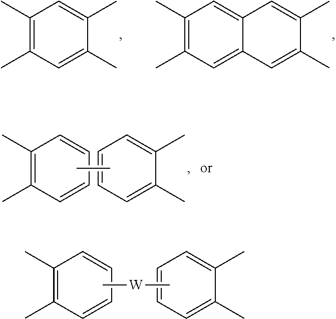

wherein W is —O—, —S—, —C(O)—, —SO₂—, —SO—, —C_{y}H_{2y}— wherein y is an integer from 1 to 5 or a halogenated derivative thereof (which includes perfluoroalkylene groups), or a group of the formula T as described in formula (3) below.

Each R in formula (1) is the same or different, and is a substituted or unsubstituted divalent organic group, such as a C₆₋₂₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof, in particular a divalent group of formulas (2)

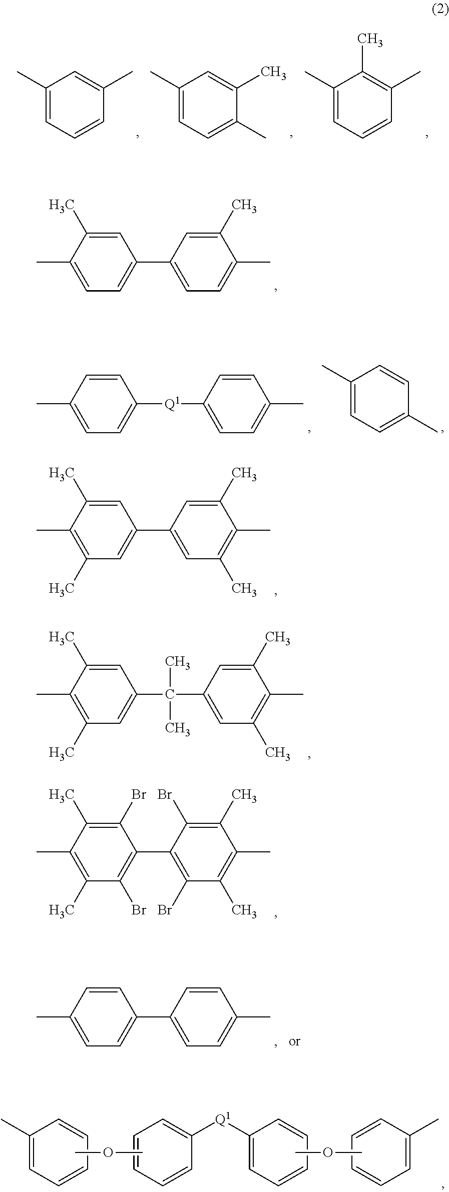

wherein Q¹ is —O—, —S—, —C(O)—, —SO₂—, —SO—, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In an embodiment R is m-phenylene, p-phenylene, or a diaryl sulfone.

Polyetherimides are a class of polyimides that comprise more than 1, for example 3 to 1000, or 5 to 500, or 10 to 100 structural units of formula (3)

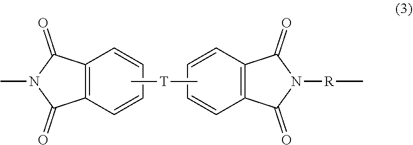

wherein each R is the same or different, and is as described in formula (1).

Further in formula (3), T is —O— or a group of the formula —O—Z—O— wherein the divalent bonds of the —O— or the —O—Z—O— group are in the 3,3′, 3,4′, 4,3′, or the 4,4′ positions. The group Z in —O—Z—O— of formula (1) is a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups derived from a dihydroxy compound of formula (4)

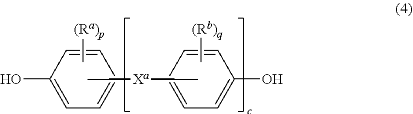

wherein R^{a} and R^{b} can be the same or different and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (4a)

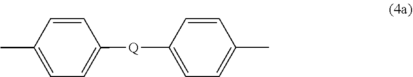

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment in formula (3), R is m-phenylene or p-phenylene and T is —O—Z—O— wherein Z is a divalent group of formula (4a). Alternatively, R is m-phenylene or p-phenylene and T is —O—Z—O wherein Z is a divalent group of formula (4a) and Q is 2,2-isopropylidene.

In some embodiments, the polyetherimide can be a copolymer, for example, a polyetherimide sulfone copolymer comprising structural units of formula (1) wherein at least 50 mole % of the R groups are of formula (2) wherein Q¹ is —SO₂— and the remaining R groups are independently p-phenylene or m-phenylene or a combination comprising at least one of the foregoing; and Z is 2,2′-(4-phenylene)isopropylidene.

Alternatively, the polyetherimide copolymer optionally comprises additional structural imide units, for example imide units of formula (1) wherein R and V are as described in formula (1), for example V is

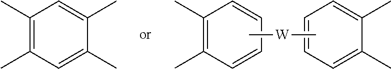

wherein W is a single bond, —S—, —C(O)—, —SO₂—, —SO—, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide. The polyimide and polyetherimide can be prepared by any of the methods well known to those skilled in the art, including the reaction of an aromatic bis(ether anhydride) of formula (5a) or formula (5b)

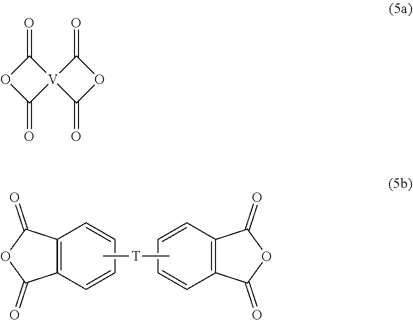

or a chemical equivalent thereof, with an organic diamine of formula (6)

H₂N—R—NH₂ (6)

wherein V, T, and R are defined as described above. Copolymers of the polyetherimides can be manufactured using a combination of an aromatic bis(ether anhydride) of formula (5) and a different bis(anhydride), for example a bis(anhydride) wherein T does not contain an ether functionality, for example T is a sulfone.

Illustrative examples of bis(anhydride)s include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, as well as various combinations thereof.

Examples of organic diamines include hexamethylenediamine, polymethylated 1,6-n-hexanediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. Combinations of these compounds can also be used. In some embodiments the organic diamine is m-phenylenediamine, p-phenylenediamine, 4,4′-diaminodiphenyl sulfone, or a combination comprising at least one of the foregoing.

The polyimide can be a copolymer with a siloxane. A poly(siloxane-etherimide) copolymer comprises polyetherimide units of formula (3) and siloxane blocks of formula (7)

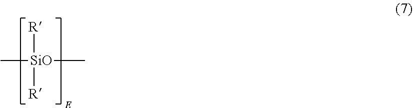

wherein E of the siloxane is 2 to 50, 5, to 30, or 10 to 40; each R′ is independently a C₁₋₁₃ monovalent hydrocarbyl group. For example, each R′ can independently be a C₁₋₁₃ alkyl group, C₁₋₁₃ alkoxy group, C₂₋₁₃ alkenyl group, C₂₋₁₃ alkenyloxy group, C₃₋₆ cycloalkyl group, C₃₋₆ cycloalkoxy group, C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups can be fully or partially halogenated with fluorine, chlorine, bromine, or iodine, or a combination comprising at least one of the foregoing. In an embodiment no bromine or chlorine is present, and in another embodiment no halogens are present. Combinations of the foregoing R groups can be used in the same copolymer. In an embodiment, the polysiloxane blocks comprises R′ groups that have minimal hydrocarbon content. In a specific embodiment, an R′ group with a minimal hydrocarbon content is a methyl group.

The poly (siloxane-etherimide)s can be formed by polymerization of an aromatic bisanhydride and a diamine component comprising an organic diamine as described above or mixture of diamines, and a polysiloxane diamine of formula (8)

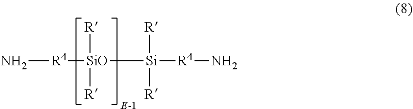

wherein R′ and E are as described in formula (7), and R⁴ is each independently a C₂-C₂₀ hydrocarbon, in particular a C₂-C₂₀ arylene, alkylene, or arylenealkylene group. In an embodiment R⁴ is a C₂-C₂₀ alkylene group, specifically a C₂-C₁₀ alkylene group such as propylene, and E has an average value of 5 to 100, 5 to 75, 5 to 60, 5 to 15, or 15 to 40. Procedures for making the polysiloxane diamines of formula (8) are well known in the art.

In some poly(siloxane-etherimide)s the diamine component can contain 10 to 90 mole percent (mol %), or 20 to 50 mol %, or 25 to 40 mol % of polysiloxane diamine (8) and 10 to 90 mol %, or 50 to 80 mol %, or 60 to 75 mol % of diamine (6), for example as described in U.S. Pat. No. 4,404,350. The diamine components can be physically mixed prior to reaction with the bisanhydride(s), thus forming a substantially random copolymer. Alternatively, block or alternating copolymers can be formed by selective reaction of (6) and (8) with aromatic bis(ether anhydrides (5), to make polyimide blocks that are subsequently reacted together. Thus, the poly(siloxane-imide) copolymer can be a block, random, or graft copolymer. In an embodiment the copolymer is a block copolymer.

Examples of specific poly(siloxane-etherimide)s are described in U.S. Pat. Nos. 4,404,350, 4,808,686 and 4,690,997. In an embodiment, the poly(siloxane-etherimide) has units of formula (9)

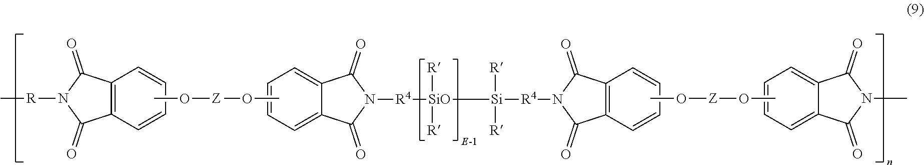

wherein R′ and E of the siloxane are as in formula (5), the R and Z of the imide are as in formula (1), R⁴ is the same as R⁴ as in formula (8), and n is an integer from 5 to 100. In a specific embodiment, the R of the etherimide is a phenylene, Z is a residue of bisphenol A, R⁴ is n-propylene, E is 2 to 50, 5, to 30, or 10 to 40, n is 5 to 100, and each R′ of the siloxane is methyl.

The relative amount of polysiloxane units and etherimide units in the poly(siloxane-etherimide) depends on the desired properties, and are selected using the guidelines provided herein. In particular, as mentioned above, the block or graft poly(siloxane-etherimide) copolymer is selected to have a certain average value of E, and is selected and used in amount effective to provide the desired wt % of polysiloxane units in the composition. In an embodiment the poly(siloxane-etherimide) comprises 10 to 50 wt %, 10 to 40 wt %, or 20 to 35 wt % polysiloxane units, based on the total weight of the poly(siloxane-etherimide).

The polyimides and polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide polymer has a weight average molecular weight (Mw) of 1,000 to 150,000 grams/mole (Dalton), as measured by gel permeation chromatography, using polystyrene standards. In some embodiments the polyetherimide has an Mw of 10,000 to 80,000 Daltons. Such polyetherimide polymers typically have an intrinsic viscosity greater than 0.2 deciliters per gram (dl/g), or, more specifically, 0.35 to 0.7 dl/g as measured in m-cresol at 25° C.

The composite includes a vulcanizing agent. Vulcanizing agents include aromatic or aliphatic polyhydroxy aromatic compounds, or derivatives thereof, such as di-, tri- and tetrahydroxy benzenes, naphthalenes, or anthracenes, bisphenols in which the two aromatic rings are bonded together via a divalent aliphatic, cycloaliphatic or aromatic radical, or via an oxygen or sulfur atom, or alternatively a carbonyl group. The aromatic rings can be substituted with one or more chlorine, fluorine, or bromine atoms or with carbonyl, alkyl, or acyl groups. Bisphenol AF, bisphenol A and hydroquinone are exemplary vulcanizing agents.

Vulcanizing agents also include amine vulcanizing agents such as hexamethylene diamine, hexamethylene diamine dicarbamate, and dicinnamylidene hexamethylene diamine.

The composite can further include an additive composition comprising one or more additives that are generally known in the art to be useful for polymeric compositions, with the proviso that the one or more additives do not significantly adversely affect one or more of the desired properties of the composition. In an aspect, the additive is a rubber accelerator, a thermal stabilizer, a UV stabilizer, or a combination comprising at least one of the foregoing.

Rubber accelerators can optionally be present, which include quaternary ammonium or phosphonium salts such as quaternary phosphonium salts and aminophosphonium salts. Exemplary rubber accelerators include tetrabutyl ammonium acid sulfate, tetrabutyl ammonium bromide, 8-benzyl-1,8-diazabicyclo [5.4.0.] undeca-7-enium chloride, p-toluenesulfonic acid, 1,8-diazabicyclo [5.4.0.] undeca-7-eniuin, tetrabutyl phosphonium chloride, trioctylmethyl phosphonium chloride, triphenyl benzyl phosphonium chloride, 1,8-diazabicyclo [5.4.0.] undeca-7-salt, pyridine, tributylamine, triphenylphosphine, tributylphosphite, and the like.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec) or combinations comprising at least one of the foregoing light stabilizers.

Thermal stabilizer additives include organophosphites (e.g. triphenyl phosphite, tris-(2,6-dimethylphenyl)phosphite, tris-(mixed mono-and di-nonylphenyl)phosphite or the like), phosphonates (e.g, dimethylbenzene phosphonate or the like), phosphates (e.g., trimethyl phosphate, or the like), or combinations comprising at least one of the foregoing heat stabilizers. The heat stabilizer can be tris(2,4-di-t-butylphenyl) phosphate available as IRGAPHOS™ 168.

Additional additives can include an impact modifier, flow modifier, filler, reinforcing agent, antioxidant, heat stabilizer, light stabilizer, ultraviolet (UV) light stabilizer, UV absorbing additive, plasticizer, lubricant, release agent, antistatic agent, anti-fog agent, antimicrobial agent, colorant (e.g., a dye or pigment), surface effect additive, radiation stabilizer, flame retardant, anti-drip agent, or a combination comprising one or more of the foregoing. The additional additive can generally be included in any amount that is known to be effective, for example 0 to 20 weight percent, for example 0.1 to 10 weight percent based on the total weight of the polymer components (e.g., the polyimide, fluoroelastomer, or combination thereof).

In an embodiment, the additional additives include a filler, for example a particulate mineral filler or reinforcing fibers. Possible fillers or reinforcing agents include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well combinations comprising at least one of the foregoing fillers or reinforcing agents. The fillers and reinforcing agents can be coated with a layer of metallic material to facilitate conductivity, or surface treated with silanes to improve adhesion and dispersion with the polymer matrix. Fillers can be used in amounts of 1 to 200 parts by weight, based on 100 parts by weight of the total composition.

A method of making a composite comprises blending a fluoroelastomer, 0.1 to 5.0 parts by weight of a vulcanizing agent per hundred parts of the fluoroelastomer, 5 to 50 parts by weight of a polyimide per hundred parts by weight of the fluoroelastomer, and 0 to 20 parts by weight of an additive composition per hundred parts by weight of the fluoroelastomer, to provide a composition comprising the polyimide substantially evenly dispersed in the fluoroelastomer. The composition is then cured. Temperature, time, and pressure conditions for effective cure depend on the particular elastomer and cure agent used, as well as their relative amounts, and are known to those of ordinary skill in the art. For example, cure can be conducted at 50 to 200° C., for 10 minutes to 3 hours, at a pressure greater than atmospheric, for example 0.5 to 50 megaPascal (MPa). In an embodiment, the polyimide is in powder form and has a particle diameter of 1 μm to 1 mm.

Also included herein are articles comprising the fluoroelastomer-polyimide composite described herein. In some embodiments the article comprises a metal substrate and the fluoroelastomer-polyimide composite disposed on at least a portion of the metal substrate. The metal substrate can have any configuration, for example a layer or other three-dimensional form. Articles comprising the metal substrate and the fluoroelastomer-polyimide composite are also disclosed. Exemplary articles include sealing devices or devices requiring vibration dampening such as O-rings, gaskets, pipes, fittings, hoses, stem seals, shaft seals, diaphragms, electric wires, shock-absorbing materials, and the like. In a preferred embodiment, the articles are used under severe environments such as in automotive, aerospace, and oil and gas applications.

The invention is further illustrated by the following Examples.

### EXAMPLES

In the following Examples, hardness was tested via a Shore durometer according to ASTM D 2240.

The tensile testing was conducted using a tensile machine according to ASTM D 412.

Density was tested according to ASTM D297.

FL, T10, T50, T90, and Fmax were test on a vulcameter (rubber vulcanization machine) according to ASTM D5289/ASTM D2084/GBT16584. FL is the minimum torque. T10, T50, T90 are scorch time, in minutes, time to an increase of 10, 50, 90 units of force or torque from FL according to ASTM5298. F max is the maximum force when the vulcanization curve turns flat.

Compression set was determined according to ASTM D623, a percentage of original thickness as CA.

CA=[(to−ti)/to]*100, where to=original thickness and ti=final thickness.

Brittleness was determined according to GB1682.

Dimensional change was determined by measurement of volume changing ratio according to GB1690 before and after heat aging or chemical exposure, and is given in percent.

For automotive transmission gear box bench testing, two samples were formed into seals for as shown in FIG. 2. The seals were assembled to the gear box with transmission oil inside After a certain number of hours, if no oil was leaking from the seal as determined by a visual check, the test was marked as pass, otherwise the test was marked as fail.

### Examples 1-2

A composite of FKM (a terpolymer of tetrafluoroethylene (TFE), vinylidene fluoride (VDF) and hexafluoropropylene (HFP)), polyetherimide (PEI) powder, and a vulcanizing agent was made by blending the three components using a mixing mill (an open mill) with two rollers at room temperatures in amounts according to the Table. The vulcanizing agent was bisphenol AF (hexafluorobisphenol A) in an amount of 2.5 parts by weight based on parts by weight of the rubber (phr), and the polyetherimide was ULTEM™ 1000F3SP-1000 from SABIC. Formation of a “triangle shape” followed by a “sheet shape” was performed 10 times or more to provide a composite in which the PEI powder was fully dispersed in the FKM fluoroelastomer. Once the blending process was complete, 3 mm-thick sheets were prepared for curing. Curing was performed at 170° C. for 10 minutes via a vulcameter followed by post curing at 200° C. for 16 hours to complete sample preparation for testing.

A neat FKM (FTE-HFP-VDF) rubber (Comparative Ex. 1) was compared to a composite of FKM with PEI (Ex. 2). The properties are provided in Table 1.

TABLE 1

| | | CEx. 1 | Ex. 2 |
|---|---|---|---|
| Component | Unit | (Neat rubber) | (Composite) |
| FKM (FTE-HFP-VDF) | Phr | 100 | 100 |
| PEI | Phr | — | 10 |
| Vulcanizing agent | Phr | 2.5 | 2.5 |
| Properties | Unit | CEx. 1 | Ex. 2 |
| Shore A Hardness | | 73 | 81 |
| Density | g/cm³ | 2.12 | 2.07 |
| Tensile strength at | MPa | 6.79 | 9.09 |
| 100% elongation | | | |
| Tensile strength at break | MPa | 15.22 | 16.28 |
| Elongation | % | 223 | 193 |
| F max | dN · m | 1.505 | 1.596 |
| T10 | min | 2.03 | 1.46 |
| T90 | min | 4.21 | 4.58 |

As can be seen in Table 1, the composites according to the present disclosure (Ex. 2) had enhanced mechanical performance and comparable curing (vulcanization) behavior compared to the neat fluoroelastomer (CEx. 1).

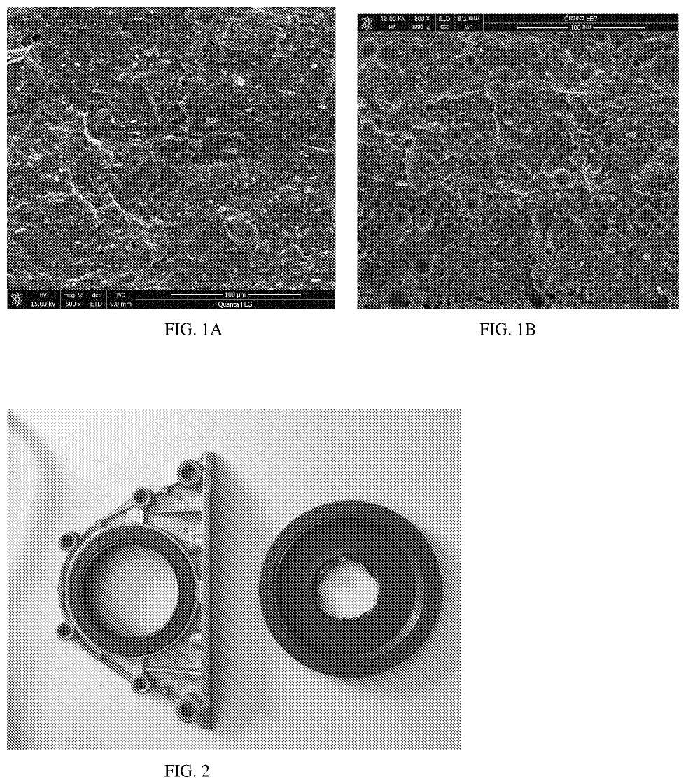

A scanning electron micrograph (SEM) of CEx. 1 is shown in FIG. 1A, and an SEM of Ex. 2 is shown in FIG. 1B. As can be seen, the PEI powders are well dispersed in the rubber matrix with good compatibility which enhances the mechanical performance.

### Examples 3-7

These Examples were prepared as described above.

A neat composition containing FKM/VDF-HFP/vulcanizing chemical precompound and FKM rubber but no PEI (Comparative Ex. 3) was compared to the same fluoroelastomer composition with PEI (Ex. 4 and 6) or PEI-Si (Ex. 5 and 7). The properties of the Examples were tested before and after heat aging or exposure to chemical conditions, e.g., fuel and oil. The properties are shown in Table 2.

In addition, two examples were formed into an automotive sealing part, and bench tested for use as an automotive transmission gear box for 500 hours, 1000 hours and 1500 hours.

TABLE 2

| Component (phr) | Grade and Source | CEx. 3 | Ex. 4 | Ex. 5 | Ex. 6 | Ex. 7 |
|---|---|---|---|---|---|---|
| Precompounded FKM, | A401C (DuPont) | 80 | 80 | 80 | 80 | 80 |
| VDF-HFP, and cure agent | | | | | | |
| FKM rubber | CG2602 (local) | 20 | 20 | 20 | 20 | 20 |
| Wax | C-WAX | 1 | 1 | 1 | 1 | 2 |
| MgO | MA150 | 3 | 3 | 3 | 3 | 3 |
| CaOH₂ | OMM-2 | 6 | 6 | 6 | 6 | 6 |
| CaSiO₃ | 600EST | 30 | 20 | 20 | 30 | 20 |
| PEI | 1000FP-1000 (SABIC) | 0 | 8 | 0 | 10 | 0 |
| PEI-Si | STM1700FP (SABIC) | 0 | 0 | 8 | 0 | 10 |

| | Units | CEx. 3 | Ex. 4 | Ex. 5 | Ex. 6 | Ex. 7 |
|---|---|---|---|---|---|---|
| Properties as made | | | | | | |
| Hardness | Shore A | 71 | 73 | 73 | 76 | 73 |
| Density | g/cm³ | 2.01 | 1.9 | 1.9 | 1.95 | 1.87 |
| 100% elongation strength | MPa | 7.04 | 5.82 | 5.81 | 8.45 | 6.26 |
| Tensile Strength | MPa | 12.41 | 11.71 | 13.7 | 14.79 | 10.39 |
| Elongation at break | MPa | 197 | 256 | 255 | 192 | 212 |
| FL | dN.M | 0.183 | 0.195 | 0.259 | 0.214 | 0.262 |
| Fmax | dN.M | 1.519 | 1.495 | 1.508 | 1.751 | 1.553 |
| T10 | min | 1.28 | 1.28 | 1.09 | 1.26 | 1.07 |
| T50 | min | 1.5 | 1.56 | 1.3 | 1.51 | 1.27 |
| T90 | min | 2.35 | 2.59 | 2.04 | 2.4 | 2.01 |
| Compression Set (200 dc * 70 hrs) | % | 23.02 | 28.78 | 43.88 | 31.88 | 40.43 |
| Properties after | | | | | | |
| Aging (250° C. for 70 hr) | | | | | | |
| Tensile strength at 100% elongation | MPa | 7.06 | | | 10.02 | 8.31 |
| Tensile Strength | MPa | 12.75 | | | 15.2 | 14.09 |
| Elongation at break | MPa | 174 | | | 182 | 183 |
| Hardness | Shore A | 71 | | | 79 | 76 |
| Properties after | | | | | | |
| Exposure to Fuel C (23° C., 70 hr) | | | | | | |
| Tensile Strength | MPa | 11.56 | | | 10.98 | 9.47 |
| Elongation at break | MPa | 193 | | | 204 | 193 |
| Hardness | Shore A | 67 | | | 72 | 71 |
| Dimensional change | % | 3.7 | | | 3.54 | 3.36 |
| Brittleness temp | ° C. | −26 | | | −18 | −20 |
| Properties after | | | | | | |
| Exposure to engine oil (5W-30, | | | | | | |
| 150° C., 94 hr) | | | | | | |
| Tensile Strength | MPa | 14.02 | | | 13.55 | 11.54 |
| Elongation at break | MPa | 172 | | | 157 | 160 |
| Hardness | MPa | 69 | | | 74 | 71 |
| Dimensional Change | % | 0.29 | | | 0.18 | 0.21 |
| Bench testing for automotive transmission | 500 hr | | Pass | Pass | | |
| gear-box | | | | | | |
| | 1000 hr | | Pass | Pass | | |
| | 1500 hr | | Pass | Pass | | |

As can be seen from the data in Table 2, PEI blended FKM rubber showed balanced performance compared with the fluoroelastomer without PEI. At the same filler loading, 30% CaSiO₃, Ex. 3 and Ex. 6, the fluoropolymer with PEI showed significant improved tensile strength compared with the fluoropolymer without PEI and the tensile strength was retained after aging and exposure to fuel and oil.

The bench testing of the seals made from the compositions of Ex. 4 and Ex. 5 show that they are suitable for use in an automotive transmission gear box.

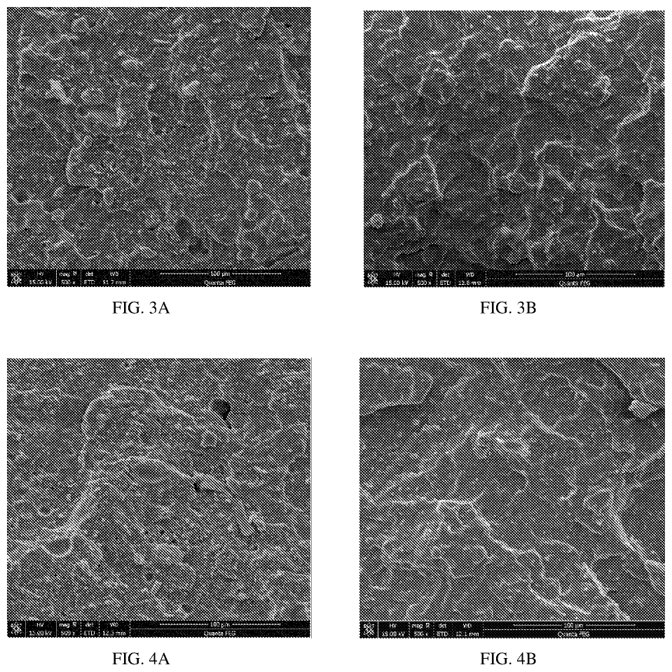

FIG. 3A is an SEM showing the composition of Ex. 4 before cure, and FIG. 3B is an SEM showing the composition of Ex. 4 after cure. As can be seen from FIGS. 3A and 3B, after the curing process, the powder containing PEI was well melted and merged with the fluoroelastomer matrix in 3B, while the PEI powder could be observed in FIG. 3A before the curing.

FIG. 4A is an SEM showing the composition of Ex. 5 before cure, and FIG. 4B is an SEM showing the composition of Ex. 5 after cure. As can be seen from FIGS. 4A and 4B, after the curing process, the powder containing PEI was well melted and merged with the fluoroelastomer matrix in 4B, while the PEI powder could be observed in FIG. 4A before the curing.

This disclosure further encompasses the following non-limiting embodiments.

### Embodiment 1

A composite comprising

a fluoroelastomer,

0.1 to 5.0 parts by weight of a vulcanizing agent, based on 100 parts by weight of the fluoroelastomer,

5 to 50 parts by weight of a polyimide, based on 100 parts by weight of the fluoroelastomer, and

0 to 20 parts by weight of an additive, based on 100 parts by weight of the fluoroelastomer.

### Embodiment 2

The composite of claim 1, wherein the additive composition comprises a vulcanizing agent, a rubber accelerator, a thermal stabilizer, a UV stabilizer, or a combination comprising at least one of the foregoing.

### Embodiment 3

The composite of any one or more of claims 1 and 2, wherein the fluoroelastomer is a copolymer of hexafluoropropylene and vinylidene fluoride; a terpolymer of tetrafluoroethylene, vinylidene fluoride and hexafluoropropylene; a perfluoromethylvinylether, or a combination comprising at least one of the foregoing.

### Embodiment 4

The composite of any one or more of claims 1 to 3, wherein the polyimide is a homopolymer or copolymer comprising 3 to 1000, or 5 to 500, or 10 to 100 units of the formula:

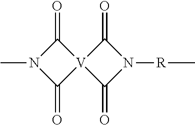

wherein
each V is the same or different, and is a substituted or unsubstituted tetravalent C₄₋₄₀ hydrocarbon group, and
each R is the same or different, and is a substituted or unsubstituted C₂₋₂₀ divalent organic group.

### Embodiment 5

The composite of any one or more of claims 1 to 4, wherein the polyimide is a polyetherimide homopolymer or copolymer comprising units of the formula

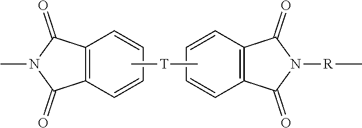

wherein
R is as defined in claim 1,
T is —O— or a group of the formula —O—Z—O— wherein the divalent bonds of the —O— or the —O—Z—O— group are in the 3,3′, 3,4′, 4,3′, or the 4,4′ positions, and
Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded.

### Embodiment 6

The composite of claim 5, wherein R is a group of the formula

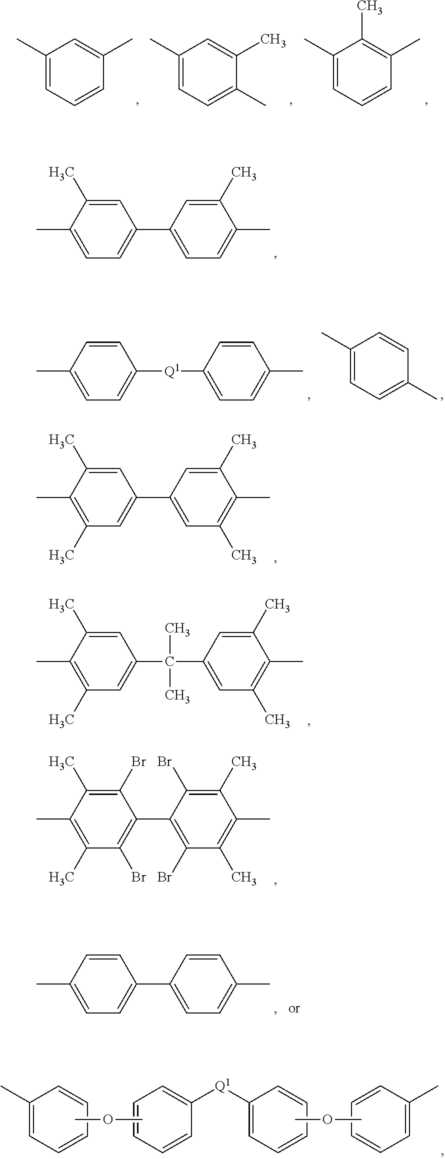

wherein Q1 is —O—, —S—, —C(O)—, —SO₂—, —SO—, -CyH₂y- and a halogenated derivative thereof,
wherein y is an integer from 1 to 5, or —(C₆H₁₀)_{z}—, wherein z is an integer from 1 to 4; and

Z is a group derived from a dihydroxy compound of the formula

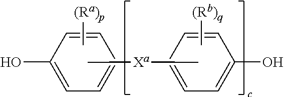

wherein

R^{a} and R^{b} are each independently a halogen atom or a monovalent C₁₋₆ alkyl group;

p and q are each independently integers of 0 to 4;

c is 0 to 4; and

Xa is a single bond, —O—, —S—, —S(O)—, —SO₂—, —C(O)—, or a C₁₋₁₈ organic bridging group.

### Embodiment 7

The composite of claim 5, wherein each R is independently meta-phenylene or para-phenylene, and Z is 4,4′-diphenylene isopropylidene.

### Embodiment 8

The composite of claim 5, wherein the polyetherimide is a copolymer comprising units of the formula

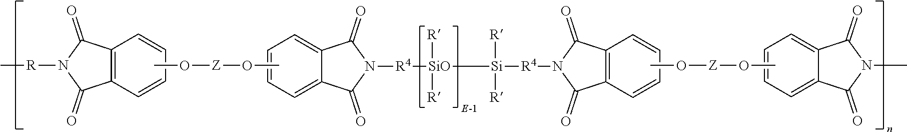

wherein

the R and Z are as in claim 3,

each R′ is independently a C₁₋₁₃ monovalent hydrocarbyl group,

each R⁴ is independently a C₂₋₂₀ hydrocarbyl group,

E is 2 to 50, 5 to 30, or 10 to 40, and

n is an integer from 3 to 1000, or 5 to 500, or 10 to 100.

### Embodiment 9

The composite of any one or more of claims 1 to 8, wherein the composite has a tensile strength that is at least 25% greater than that than that of the same composition without the polyimide, measured according to ASTM D 412.

### Embodiment 10

The composite of any one or more of claims 1 to 9, wherein the composite has superior metal adhesion compared to the same composition without the polyimide.

### Embodiment 11

A method of making a composite, comprising

combining the components of any one or more of claims 1 to 10, to provide a composite comprising the polyimide substantially evenly dispersed in the fluoroelastomer; and

curing the fluoroelastomer.

### Embodiment 12

The method of claim 10, wherein the polyimide is in powder form and has a particle diameter of 1 μm to 1 mm.

### Embodiment 13

An article comprising the composite of any one or more of claims 1 to 12.

### Embodiment 14

The article of claim 13, comprising a metal substrate wherein the composite is disposed on at least a portion of the metal substrate.

### Embodiment 15

The article of any one or more of claims 13 to 14, wherein the article is a sealing device or an article requiring vibration dampening.

The assemblies, methods, and devices can alternatively comprise, consist of, or consist essentially of, any appropriate components or steps herein disclosed. The assemblies, methods, and devices can additionally, or alternatively, be manufactured so as to be devoid, or substantially free, of any steps, components, materials, ingredients, adjuvants, or species that are otherwise not necessary to the achievement of the function or objectives of the assemblies, methods, and devices.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments,” “an embodiment,” and so forth, means that a particular element described in connection with the embodiment is included in at least one embodiment described herein, and may or may not be present in other embodiments. In addition, it is to be understood that the described elements can be combined in any suitable manner in the various embodiments.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference. Unless specified otherwise, all standards (e.g., ASTM, ISO, and others), are the most recent version as of May 1, 2016.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl) a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen can arise to applicants or others skilled in the art. Accordingly, the appended claims as filed and as they may be amended are intended to embrace all such alternatives, modifications variations, improvements, and substantial equivalents.

1. A composite, comprising
a fluoroelastomer,
0.1 to 5.0 parts by weight of a vulcanizing agent, based on 100 parts by weight of the fluoroelastomer,
0 to 20 parts by weight of an additive composition, based on 100 parts by weight of the fluoroelastomer, and
5 to 50 parts by weight of a polyimide, based on 100 parts by weight of the fluoroelastomer.

2. The composite of claim 1, wherein the additive composition comprises a rubber accelerator, a thermal stabilizer, an ultraviolet light stabilizer, or a combination comprising at least one of the foregoing.

3. The composite of claim 1, wherein the fluoroelastomer is a copolymer of hexafluoropropylene and vinylidene fluoride; a terpolymer of tetrafluoroethylene, vinylidene fluoride and hexafluoropropylene; a perfluoromethylvinylether, or a combination comprising at least one of the foregoing.

4. The composite of claim 1, wherein the polyimide is a homopolymer or copolymer comprising 3 to 1000 units of the formula: 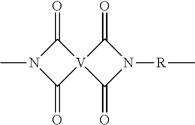
wherein
each V is the same or different, and is a substituted or unsubstituted tetravalent C₄₋₄₀ hydrocarbon group, and
each R is the same or different, and is a substituted or unsubstituted C₂₋₂₀ divalent organic group.

5. The composite of claim 1, wherein the polyimide is a polyetherimide homopolymer or copolymer comprising units of the formula 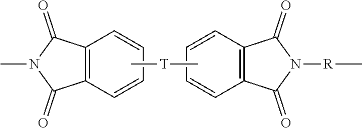
wherein
R is as defined in claim 1,
T is —O— or a group of the formula —O—Z—O— wherein the divalent bonds of the —O— or the —O—Z—O— group are in the 3,3′, 3,4′, 4,3′, or the 4,4′ positions, and
Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded.

6. The composite of claim 5, wherein
R is a group of the formula 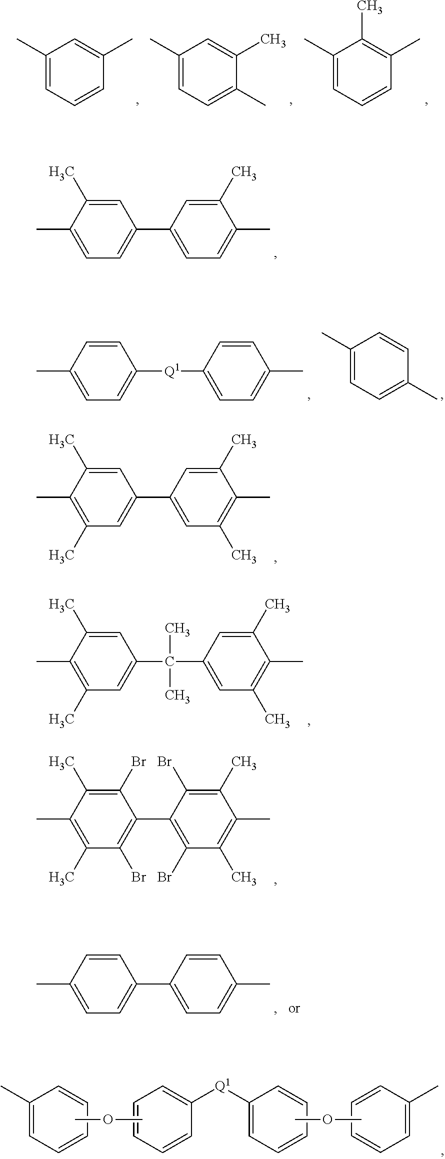
wherein Q¹ is —O—, —S—, —C(O)—, —SO₂—, —SO—, —C_{y}H_{2y}— and a halogenated derivative thereof, wherein y is an integer from 1 to 5, or —(C₆H₁₀)_{z}—, wherein z is an integer from 1 to 4; and
Z is a group derived from a dihydroxy compound of the formula 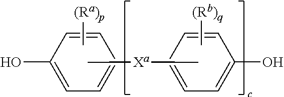
wherein
R^{a} and R^{b} are each independently a halogen atom or a monovalent C₁₋₆ alkyl group;
p and q are each independently integers of 0 to 4;
c is 0 to 4; and
X^{a} is a single bond, —O—, —S—, —S(O)—, —SO₂—, —C(O)—, or a C₁₋₁₈ organic bridging group.

7. The composite of claim 5, wherein each R is independently meta-phenylene or para-phenylene, and Z is 4,4′-diphenylene isopropylidene.

8. The composite of claim 5, wherein the polyetherimide is a copolymer comprising units of the formula 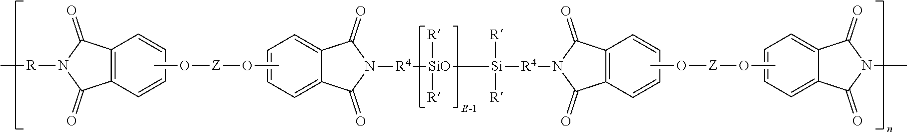
wherein
the R and Z are as in claim 3,
each R′ is independently a C₁₋₁₃ monovalent hydrocarbyl group,
each R⁴ is independently a C₂₋₂₀ hydrocarbyl group,
E is 2 to 50, and
n is an integer from 3 to 1000.

9. The composite of claim 1, wherein the composite has a tensile strength that is at least 25% greater than that of the same composition without the polyimide, measured according to ASTM D412.

10. The composite of claim 1, wherein the composite has superior metal adhesion compared to the same composition without the polyimide.

11. A method of making the composite of claim 1, the method comprising
combining the components of claim 1, to provide a composite comprising the polyimide substantially evenly dispersed in the fluoroelastomer; and
curing the fluoroelastomer.

12. The method of claim 11, wherein the polyimide is in powder form and has a particle diameter of 1 micrometer to 1 millimeter.

13. An article comprising the composite of claim 1.

14. The article of claim 13, comprising a metal substrate wherein the composite is disposed on at least a portion of the metal substrate.

15. The article of claim 13, wherein the article is a sealing device or an article in need of vibration dampening.
